(19) United States
(12) Patent Application Publication
(10) Pub. No.: US 2025/0190158 A1
(43) Pub. Date: Jun. 12, 2025

(54) INFORMATION PROCESSING APPARATUS, PRINTING SYSTEM, AND PROGRAM

(71) Applicant: SEIKO EPSON CORPORATION, Tokyo (JP)

(72) Inventor: Tetsuya WAKASA, Sapporo (JP)

(21) Appl. No.: 18/973,183

(22) Filed: Dec. 9, 2024

(30) Foreign Application Priority Data
Dec. 11, 2023 (JP) 2023-208309

(51) Int. Cl. G06F 3/12

(52) U.S. Cl. CPC G06F 3/1261; G06F 3/1205; G06F 3/1253

(57) ABSTRACT

An information processing apparatus according to an aspect of the present disclosure includes a controller, a display section, an operation section, and a communication section. The controller causes the display section to display a content selection image from which a printing target content is selected and evaluates whether the printing target content selected via the operation section can be printed by a second printing apparatus different from a first printing apparatus capable of printing the printing target content. When the printing target content is printable by the second printing apparatus, the controller causes the display section to display a first apparatus selection image from which one of the first and second printing apparatuses is selected as a printing apparatus that prints the printing target content. The controller transmits a print job of printing the printing target content via the communication section to a printing apparatus selected from the first apparatus selection image via the operation section.

The present application is based on, and claims priority from JP Application Serial Number 2023-208309, filed Dec. 11, 2023, the disclosure of which is hereby incorporated by reference herein in its entirety.

### BACKGROUND

### 1. Technical Field

The present disclosure relates to an information processing apparatus, a printing system, and a program.

### 2. Related Art

JP-A-2021-071838 discloses a technology for specifying a content stored in a Web server via a terminal device such as a smartphone and printing a document containing the content.

JP-A-2021-071838 is an example of the related art.

The technology described in JP-A-2021-071838, however, does not take account of grasping a user's printing environment via the Web server. When the user's printing environment cannot be grasped via the Web server, there is a risk that a web content may be printed by a printing apparatus that is not very suitable for the web content, or that a web content that cannot be printed by the user's printing apparatus may be presented. As a result, there is a possibility of causing the user to redo the user's operation, such as selection of a content or a printing apparatus.

It is therefore desired to develop a technology that allows improvement in the user's convenience in printing a content that matches the user's printing environment.

### SUMMARY

An information processing apparatus according to an aspect of the present disclosure includes: a display section; an operation section; a communication section; and a controller, and the controller is configured to cause the display section to display a content selection image that is a user interface image from which a printing target content is selected, evaluate whether the printing target content selected from the content selection image via the operation section is printable by a second printing apparatus that is a printing apparatus different from a first printing apparatus capable of printing the printing target content, when the printing target content is printable by the second printing apparatus, cause the display section to display a first apparatus selection image that is a user interface image from which one of the first and second printing apparatuses is selected as a printing apparatus that prints the printing target content, and
transmit a print job of printing the printing target content via the communication section to a printing apparatus selected from the first apparatus selection image via the operation section.

An information processing apparatus according to another aspect of the present disclosure includes: a display section; an operation section; a communication section; and a controller, and the controller is configured to detect, as candidate printing apparatuses, a printing apparatus capable of transmitting a print job via a network connected to the information processing apparatus via the communication section, carry out a generation process of generating access information that includes a candidate parameter that is a parameter indicating print positions of the detected candidate printing apparatuses and indicates an access destination allowing access to a server apparatus configured to store the printing target content, and access the server apparatus via the communication section based on the access information.

A printing system according to an aspect of the present disclosure includes: an information processing apparatus including a display section, an operation section, a communication section, and a controller; a first printing apparatus; and a second printing apparatus, and the controller is configured to cause the display section to display a content selection image that is a user interface image from which a printing target content is selected, when the printing target content selected from the content selection image via the operation section is printable by the first printing apparatus, evaluate whether the printing target content is printable by the second printing apparatus, when the printing target content is printable by the second printing apparatus, cause the display section to display a first apparatus selection image that is a user interface image from which one of the first and second printing apparatuses is selected as a printing apparatus that prints the printing target content, and transmit a print job of printing the printing target content via the communication section to a printing apparatus selected from the first apparatus selection image via the operation section.

A program according to an aspect of the present disclosure is configured to cause a computer including a display section, an operation section, and a communication section to cause the display section to display a content selection image that is a user interface image from which a printing target content is selected, evaluate whether the printing target content selected from the content selection image via the operation section is printable by a second printing apparatus that is a printing apparatus different from a first printing apparatus capable of printing the printing target content, when the printing target content is printable by the second printing apparatus, cause the display section to display a first apparatus selection image that is a user interface image from which one of the first and second printing apparatuses is selected as a printing apparatus that prints the printing target content, and transmit a print job of printing the printing target content via the communication section to a printing apparatus selected from the first apparatus selection image via the operation section.

### BRIEF DESCRIPTION OF THE DRAWINGS

FIG. 1 is a block diagram showing an example of the configuration of a printing system including an information processing apparatus and a printing apparatus according to an embodiment.

FIG. 2 is a flowchart for illustrating an example of a printing process carried out in the printing system shown in FIG. 1.

FIG. 3 shows an example of a user interface image displayed on the information processing apparatus in the printing process shown in FIG. 2.

FIG. 4 shows an example of the user interface image displayed on the information processing apparatus in the printing process shown in FIG. 2.

FIG. 5 shows an example of the user interface

image displayed on the information processing apparatus in the printing process shown in FIG. 2.

FIG. 6 shows an alternative example of the user interface image shown in FIG. 5.

FIG. 7 shows an example of the hardware configuration of an apparatus.

### DESCRIPTION OF EMBODIMENTS

An embodiment of the present disclosure will be described below with reference to the drawings. The drawings are each merely an example illustrating the embodiment of the present disclosure. Furthermore, not all of the elements described in the embodiment of the present disclosure are essential configuration requirements of the present disclosure.

### Embodiment

System configuration

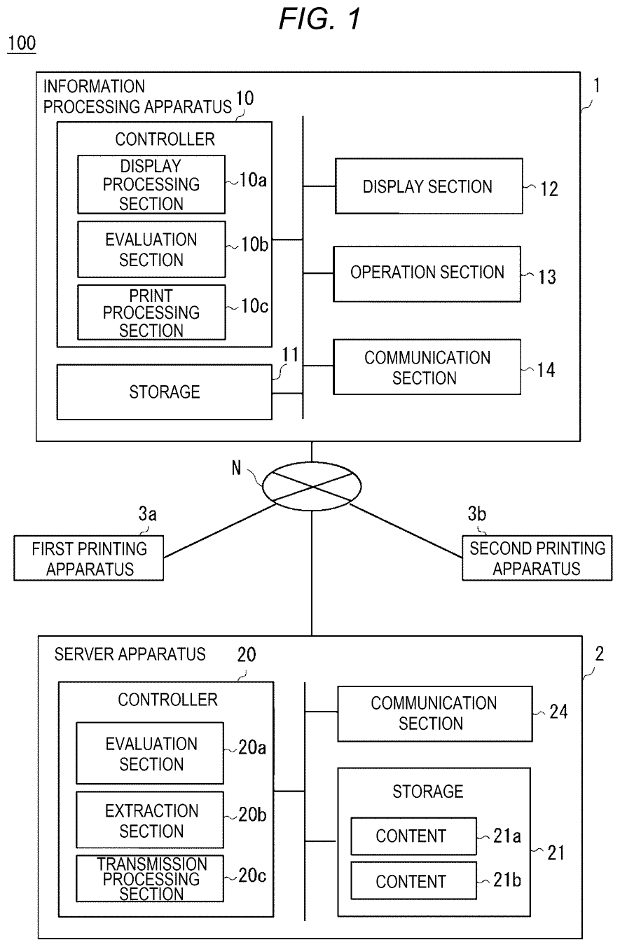

A printing system including an information processing apparatus and a printing apparatus according to the present embodiment will be described with reference to FIG. 1. FIG. 1 is a block diagram showing an example of the configuration of the printing system.

A printing system 100 according to the present embodiment may include an information processing apparatus 1, a server apparatus 2, a first printing apparatus 3a, and a second printing apparatus 3b, as shown in FIG. 1. In the printing system 100, the information processing apparatus 1, the server apparatus 2, the first printing apparatus 3a, and the second printing apparatus 3b can be connected to each other via a network N.

The information processing apparatus 1 can be a PC (personal computer), a smartphone, a tablet terminal, or the like.

The server apparatus 2 is a server computer that stores contents such as printable contents 21a and 21b and provides the information processing apparatus 1 with the contents. The server apparatus 2 can be equipped, for example, with the function of a Web server.

The printing system 100 is configured to cause the first printing apparatus 3a or the second printing apparatus 3b to print a content stored in the server apparatus 2 in response to a user's operation via the information processing apparatus 1. In particular, the printing system 100 is configured to be capable of printing a content that matches the printing environment of the user of the information processing apparatus 1. An example of the configurations of the information processing apparatus 1 and the server apparatus 2 will be described below in detail. Note that no detailed description of an example of the configuration of each of the printing apparatuses will be made.

The first printing apparatus 3a, the second printing apparatus 3b, and other printing apparatuses that will be described later may each be, for example, a printer, a facsimile apparatus, or a multifunction machine having multiple functions including at least a printing function. The printing apparatuses each operate in any of various printing methods, for example, an inkjet printing method and a laser printing method. The printing apparatuses can each also be referred to as an image forming apparatus.

### Configuration of Information Processing Apparatus 1

The information processing apparatus 1 may include a controller 10, a storage 11, a display section 12, an operation section 13, and a communication section 14, as shown in FIG. 1.

The controller 10 may include a display processing section 10a, an evaluation section 10b, and a print processing section 10c, which will be described later, to carry out processes such as selecting and printing a content that can be provided by the server apparatus 2.

The controller 10 may be configured, for example, with an arithmetic processing device such as a central processing unit (CPU) and a graphics processing unit (GPU), a working memory, and a storage device that stores a control program, parameters, and the like. The controller 10 may instead be configured with a system on a chip (SoC). As can be seen from the examples described above, the controller 10 can be configured to store the control program in an executable state. Note, however, that the controller 10 can instead be configured to store the control program as a circuit component such as a field-programmable gate array (FPGA), or can instead be configured with a dedicated circuit. The display processing section 10a, the evaluation section 10b, and the print processing section 10c can be implemented as the program described above. The program described above may include a program that realizes the functions of the display processing section 10a, the evaluation section 10b, and the print processing section 10c while the arithmetic processing device cooperates with the storage 11, the display section 12, the operation section 13, and the communication section 14. The program can also be referred to as application software. The program is, in particular, a program that carries out a printing process, and can therefore be referred to as printing application software.

The storage 11 is, for example, a hard disk drive, a solid state drive, or any other type of memory. The storage 11 can store various data such as information representing an acquired printing environment in the information processing apparatus 1 and a file used by the user. Note that the storage 11 may be a portion of a storage device in the controller 10. That is, the storage 11 can be taken as a portion of the controller 10.

The display section 12 is a portion that displays a user interface image (UI image) that allows the user to operate the information processing apparatus 1 and is configured, for example, with a display apparatus such as a liquid crystal display or an organic electroluminescence display. The display section 12 may be configured with a display and a drive circuit that drives the display.

The operation section 13 is a portion that accepts an operation performed by the user of the information processing apparatus 1, and can be referred to as an operation accepting section. The operation section 13 can be implemented, for example, by any one or more of physical buttons, a touch panel incorporated in the display section 12, a pointing device, a keyboard, and the like. In a configuration in which the operation section 13 includes the touch panel, the operation section 13 including the display section 12 and the touch panel can be collectively referred to as an operation panel of the information processing apparatus 1.

The communication section 14 is a portion that performs wireless or wired communication with an external apparatus via the network N in compliance with a predetermined communication standard such as Wi-Fi (registered trademark, the same applies below). The communication section 14 can be configured with a communication interface capable of the communication described above.

Examples of the external apparatus may include the server apparatus 2, the first printing apparatus 3a, the second printing apparatus 3b, and a print server apparatus that is not shown. The print server apparatus can be a server apparatus that manages printing performed by the first printing apparatus 3a and the second printing apparatus 3b. To simplify the description, only a configuration in which the printing system 100 does not include a print server apparatus will be described below, but the printing system may instead include a print server apparatus.

The configuration of the controller 10 will be described in detail. The display processing section 10a of the controller 10 causes the display section 12 to display a UI image via which a printing target content is selected. The UI image is hereinafter referred to as a content selection image. The content selection image is so displayed that one content can be selected from a content list by the user as the printing target content.

The first printing apparatus 3a capable of printing the printing target content may, for example, be a printing apparatus selected by the user. To allow the user to select the first printing apparatus 3a, the display processing section 10a may cause the display section 12 to display a UI image that allows the user to select a printing apparatus to be used from a list of usable printing apparatuses, and accept the user's selection operation from the operation section 13. The UI image will be described by way of example with reference to an apparatus selection image that is a UI image that allows the user to select a printing apparatus that the user desires to use from candidate printing apparatuses. The apparatus selection image will be hereinafter referred to as a second apparatus selection image.

The user may select the first printing apparatus 3a before selecting a printing target content, for example, before the content selection image is displayed, or after selecting the printing target content.

The case where the user selects the first printing apparatus 3a before selecting a printing target content will first be described. In this case, the display processing section 10a handles, as the first printing 3a, a printing apparatus selected via the apparatus operation section 13 from the second apparatus selection image, which allows the user to select a printing apparatus that the user desires to use from the candidate printing apparatuses. The display processing section 10a then causes the display section 12 to display the content selection image after a printing apparatus that the user desires to use is selected from the second apparatus selection image.

In this case, the display processing section 10a can instead acquire first apparatus information that is information on the first printing apparatus 3a, and cause the display section 12 to display the content selection image based on the first apparatus information. The information on the first printing apparatus 3a may include, for example, at least one of the model name of the first printing apparatus 3a and a code corresponding thereto. Note that the model name may indicate a product type name. The model name of the first printing apparatus 3a may be replaced with a part or all of the serial number of the first printing apparatus 3a or the product lineup of the first printing apparatus 3a classified by the manufacturer of the first printing apparatus 3a. The display processing section 10a can also transmit the first apparatus information to the server apparatus 2 via the communication section 14 and display the content selection image based on a content list returned from the server apparatus 2.

In particular, the first apparatus information may contain at least one of first medium information on a medium on which the first printing apparatus 3a can perform printing and first ink information on ink that the first printing apparatus 3a can use. The medium on which the first printing apparatus 3a can perform printing has at least one of the types and sizes that allow the first printing apparatus 3a to perform printing. Examples of the type of medium may include a plain sheet and a print sheet. The first ink information may, for example, be either information representing that only black ink capable of monochrome printing can be used or information representing that inks of multiple colors allowing color printing can be used. In this case, the display processing section 10a can also display the content selection image based on the acquired first medium information and first ink information. That is, the display processing section 10a can also transmit the first medium information and the first ink information to the server apparatus 2 via the communication section 14 and display the content selection image based on a content list returned from the server apparatus 2.

The case where the user selects the first printing apparatus 3a after selecting a printing target content will next be described. In this case, the display processing section 10a causes the display section 12 to display the content selection image based on a content list acquired by accessing the server apparatus 2. After the printing target content is selected from the content selection image, the display processing section 10a may cause the display section 12 to display the second apparatus selection image that allows the user to select a printing apparatus that the user desires to use from the candidate print apparatuses. The display processing section 10a may then handle the printing apparatus selected via the operation section 13 from the second apparatus selection image as the first printing apparatus 3a.

The first printing apparatus 3a can be determined without the user's selection. For example, the first printing apparatus 3a capable of printing a printing target content may be a printing apparatus specified by default settings. The first printing apparatus 3a capable of printing a printing target content may instead be a printing apparatus having been determined to be capable of printing the printing target content, for example, as a result of reference to a past print history.

The evaluation section 10b evaluates whether the printing target content selected via the operation section 13 from the content selection image can be printed by the second printing apparatus 3b different from the first printing apparatus 3a capable of printing the printing target content. The evaluation section 10b forwards the result of the thus performed evaluation to the display processing section 10a.

For example, the evaluation section 10b acquires second apparatus information that is information on the second printing apparatus 3b, and evaluates whether the printing target content can be printed by the second printing apparatus 3b based on the second apparatus information. In particular, the second apparatus information may contain at least one of second medium information on a medium on which the second printing apparatus 3b can perform printing and second ink information on ink that the second printing apparatus 3b can use. The medium on which the second printing apparatus 3b can perform printing has at least one of the types and sizes that allow the second printing apparatus 3b to perform printing. The second ink information may, for example, be either information representing that only black ink capable of monochrome printing can be used or information representing that inks of multiple colors allowing color printing can be used, as the first ink information.

In this case, the evaluation section 10b can also evaluate whether the printing target content can be printed by the second printing apparatus 3b based on the acquired second medium information and second ink information. The evaluation described above can be evaluation of whether the second printing apparatus 3b is more suitable than the first printing apparatus 3a, for example, whether the second printing apparatus 3b can be used to more beautifully print the printing target content than the first printing apparatus 3a. The second medium information and the second ink information may be transmitted to and evaluated by the server apparatus 2, and the result of the evaluation may be taken as the result of the evaluation made by the evaluation section 10b.

Processes after the evaluation section 10b performs the evaluation will next be described. When the selected printing target content is printable by the second printing apparatus 3b, the display processing section 10a having received the result of the evaluation from the evaluation section 10b causes the display section 12 to display a first apparatus selection image. The first apparatus selection image refers to a UI image that allows the user to select one of the first printing apparatus 3a and the second printing apparatus 3b as the printing apparatus that prints the printing target content. The printing apparatus described as the second printing apparatus 3b may be configured with multiple printing apparatuses, in which case, the first apparatus selection image is a UI image that allows the user to select one from the first printing apparatus 3a and the multiple second printing apparatuses 3b.

The print processing section 10c transmits a print job of printing the printing target content via the communication section 14, for example, via the network N to the printing apparatus selected via the operation section 13 from the first selection image. The apparatus information processing apparatus 1 can thus cause an appropriate printing apparatus to print the content.

An example of the process of displaying the first apparatus selection image will next be described. To display the first apparatus selection image, the display processing section 10a can be configured to carry out, for example, the following processes: a detection process; a generation process; and an access process.

The detection process is the process of detecting a printing apparatus capable of transmitting a print job from the information processing apparatus 1 via the network N connected via the communication section 14 as a candidate printing apparatus. In the detection process, for example, a call is broadcast to the printing apparatuses in the network N, and reception of responses to the call allows detection of printing apparatuses capable of transmitting a print job from the information processing apparatus 1. The detection process detects, for example, the first printing apparatus 3a and the second printing apparatus 3b. Note that the detection process, which searches for candidate printing apparatuses, may be referred to as a search process.

The generation process is the process of generating access information representing an access destination allowing access to a server apparatus that stores printing target contents. It is assumed in the description that the server apparatus s is the server apparatus 2. The access destination allowing access to the server apparatus 2 that stores printing target contents may be an access destination accessed for a content simply found by the user who search websites. In the generation process, the access information is generated so as to contain a first parameter that is a parameter indicating the candidate printing apparatuses detected in the detection process. The first parameter is hereinafter referred to as a candidate parameter. Information contained in the candidate parameter may be the second apparatus information described above. How the candidate parameter is used will be described later. The access information may, for example, be a URI such as a URL or a URN. The term URL is an abbreviation for the uniform resource locator. The term URN is an abbreviation for a uniform resource name. The term URI is an abbreviation for a uniform resource identifier. The following description will be made with reference to a case where the access information is a URL. The candidate parameter can be contained as a URL parameter in a URL.

The access process is the process of accessing the server apparatus 2 via the communication section 14 based on the access information described above. Since the access information contains the access destination and the candidate parameter, access is made in the access process based also on candidate parameters. The candidate parameter can be used to present a content printable by the candidate printing apparatuses to the user. That is, the server apparatus 2 having received the access information can propose, to the information processing apparatus 1, a content that is printable by the candidate printing apparatuses, such as the first printing apparatus 3a and the second printing apparatus 3b, based on the candidate parameter. The candidate parameter may also be used, for example, to propose using the second printing apparatus 3b instead of using the first printing apparatus 3a. That is, the server apparatus 2 having received the access information can also propose, to the information processing apparatus 1, information indicating the second printing apparatus 3b capable of printing the printing target content in place of the first printing apparatus 3a based on the candidate parameter.

The detection process described above can also be used when the user selects a printing apparatus that the user desires to use. That is, the display processing section 10a may carry out the process of causing the display section 12 to display the second apparatus selection image containing a list of detected printing apparatuses and allowing the user to select one printing apparatus from the list via the operation section 13. The second apparatus selection image in this case is a UI image from which a printing apparatus that the user desires to use is selected from among the candidate printing apparatuses via the operation section 13. The display processing section 10a may then select the printing apparatus selected via the operation section 13 from the second apparatus selection image as the first printing apparatus 3a that is a printing apparatus that prints the printing target content.

As described above, when the user uses the detection process described above to select a printing apparatus that the user desires to use, the generation process described above may generate access information containing the candidate parameter and a second parameter as the access information. The second parameter is hereinafter referred to as a desire parameter. The desire parameter is a parameter indicating the first printing apparatus 3a that is a printing apparatus that the user desires to use. Information contained in the desire parameter may be the first apparatus information described above. In the access process in this case, access based on the candidate parameter and the desire parameter is made. The desire parameter can also be contained in the URL as the URL parameter.

As will be described later, the server apparatus 2 in this example can be configured to extract or sort contents that can be printed by the first printing apparatus 3a selected by the user's operation via the operation section 13 based on the desire parameter. The sorting includes extraction of contents printable by the first printing apparatus 3a. The sorting may, for example, be performed in an order recommended by the server apparatus 2. More specifically, the server apparatus 2 may sort the contents in the order in which the contents generated from the same original image but different in version from each other can be printed more beautifully by the first printing apparatus 3a.

The display processing section 10a then acquires via the communication section 14 the contents extracted or sorted by the server apparatus 2 based on the desire parameter. The display processing section 10a may then cause the display section 12 to display the content selection image. The content selection image in this case is a UI image that allows the user to select a printing target content from among the acquired contents via the operation section 13. When the server apparatus 2 has sorted the contents, the content selection image contains a list of contents reflecting the result of the sorting. The user can select a printing target content via the operation section 13 while viewing the content selection image containing the thus acquired contents.

The display processing section 10a can also cause the display section 12 to display the apparatus selection image that is a UI image from which a printing apparatus proposed by the server apparatus 2 based on the candidate parameter is selected via the operation section 13 as the printing apparatus that prints the printing target content. The apparatus selection image described above will be hereinafter referred to as a third apparatus selection image. The third apparatus selection image contains the printing apparatus proposed by the server apparatus 2 as a selectable printing apparatus.

It can be said that the third apparatus selection image corresponds to an example of the first apparatus selection image. It can alternatively be said that the first apparatus selection image corresponds to an example of the third apparatus selection image. The print processing section 10c transmits a print job of printing the printing target content via the communication section 14 and the network N or any other communication path to the printing apparatus selected via the operation section 13 from the third apparatus selection image.

### Configuration of Server Apparatus 2

The server apparatus 2 may include a controller 20, a storage 21, and a communication section 24, as shown in FIG. 1.

The controller 20 may include an evaluation section 20a, an extraction section 20b, and a transmission processing section 20c, which will be described later, to cause the information processing apparatus 1 to carry out processes such as selection of a content and a printing apparatus.

The controller 20 may be configured, for example, with an arithmetic processing device, a working memory, and a storage device that stores a control program, parameters, and the like, as the controller 10. The controller 20 may instead be configured with an SoC. As can be seen from the examples described above, the controller 20 can be configured to store the control program in an executable state. Note, however, that the controller 20 can instead be configured to store the control program as a circuit component such as an FPGA, or can instead be configured with a dedicated circuit. The evaluation section 20a, the extraction section 20b, and the transmission processing section 20c can be implemented as the program described above. The program described above may include a program that realizes the functions of the evaluation section 20a, the extraction section 20b, and the transmission processing section 20c while the arithmetic processing device cooperates with the storage 21 and the communication section 24.

The storage 21 is, for example, a hard disk drive, a solid state drive, or any other type of memory, as the storage 11. Note that the storage 21 may be a portion of a storage device in the controller 20. That is, the storage 21 can be taken as a portion of the controller 20.

The storage 21 can store various data such as contents 21a and 21b, which can each be provided as a printing target to the information processing apparatus 1. In the description, only the two contents 21a and 21b are shown for the sake of convenience, and the storage 21 can, of course, store three or more contents.

The various data stored in the storage 21 may include a table in which content information that is information on each content and information on printing apparatuses of various models or product types are associated with each other so that a printing apparatus capable of appropriately printing each content can be determined. The content information may contain one or more of various types of information such as information on the resolution of a target content, information on the number of colors used to display the content, and information indicating contents having the same original image as the target content.

The communication section 24 is a portion that performs wireless or wired communication with an external apparatus via the network N in compliance with a predetermined communication standard such as Wi-Fi. The communication section 24 can be configured with a communication interface capable of the communication described above. Examples of the external apparatus may include the information processing apparatus 1, the first printing apparatus 3a, the second printing apparatus 3b, and a print server apparatus that is not shown.

The configuration of the controller 20 will be described in detail. The server apparatus 2 is a server apparatus accessed with the aid of the access destination indicated by the access information generated in the generation process in the information processing apparatus 1. The controller 20 receives the candidate parameter, or the candidate parameter and the desire parameter contained in the access information via the communication section 24. As described above, the candidate parameter is a parameter indicating candidate printing apparatuses detected in the detection process, and the desire parameter is a parameter indicating the first printing apparatus 3a that is a printing apparatus that the user desires to use. The following description will be made with reference to the case where both the candidate parameter and the desire parameter are contained in the access information.

The evaluation section 20a extracts the candidate parameter and the desire parameter from the received access information. The evaluation section 20a then evaluates based on the extracted desire parameter the first printing apparatus 3a that is a printing apparatus that the user desires to use, for example, by referring to the table described above. The evaluation section 20a evaluates based on the extracted candidate parameter candidate printing apparatuses that can perform printing in the printing environment of the information processing apparatus 1, for example, by referring to the table described above. The description below will be made on the assumption that the candidate printing apparatuses include the second printing apparatus 3b. In this example, the candidate printing apparatuses include the first printing apparatus 3a and the second printing apparatus 3b.

The extraction section 20b extracts contents printable by the first printing apparatus 3a based on the desire parameter from the contents 21a and 21b and other contents stored in the storage 21. For example, the contents 21a and 21b can be extracted or only the content 21a can be extracted. For example, the extraction section 20b can extract or sort contents printable by the first printing apparatus 3a based on the first medium information and the first ink information contained in the desire parameter. In the extraction described above, the extraction section 20b can extract contents printable by the first printing apparatus 3a including those different in version from each other. The sorting can, for example, be performed in an order recommended by the server apparatus 2. More specifically, the extraction section 20b can sort the contents in the order in which the contents generated from the same original image but different in version from each other can be printed more beautifully by the first printing apparatus 3a. When the access destination indicated by the access information is an access destination where a content has been already specified, the extraction section 20b can also extract contents printable by the first printing apparatus 3a but different in version from the specified content.

Furthermore, the evaluation section 20a acquires via the communication section 24 information representing a content selected from the content selection image provided from the information processing apparatus 1, and determines the content as the printing target content among the extracted content. The evaluation section 20a then evaluates, for example, by referring to the table described above whether the printing target content is printable by the candidate printing apparatuses other than the first printing apparatus 3a based on the candidate parameter. The following description will be made with reference to the second printing apparatus 3b as an example of the candidate printing apparatuses. The evaluation section 20a can evaluate whether the printing target content is printable by the second printing apparatus 3b, for example, by referring to the table described above based on the second medium information and the second ink information contained in the candidate parameter. The evaluation described above may be evaluation of whether the second printing apparatus 3b is more suitable than the first printing apparatus 3a, for example, whether the second printing apparatus 3b can be used to more beautifully print the printing target content than the first printing apparatus 3a.

The transmission processing section 20c can transmit the result of the evaluation of the candidate printing apparatuses to the information processing apparatus 1 via the communication section 24. The information processing apparatus 1 can thus display the second apparatus selection image described above.

The transmission processing section 20c further transmits the extracted or sorted contents or addresses that allow the information processing apparatus 1 to display the contents to the information processing apparatus 1 via the communication section 24. The information processing apparatus 1 can thus display the content selection image described above.

The transmission processing section 20c can further transmit the result of the evaluation of whether the printing target content is printable by the second printing apparatus 3b to the information processing apparatus 1 via a the communication section 24. The transmission processing section 20c can instead transmit information printing with the second printing apparatus 3b to the information processing apparatus 1 via the communication section 24 only when the printing target content is printable by the second printing apparatus 3b as a result of the evaluation of whether the printing target content is printable by the second printing apparatus 3b. The information that recommends the printing refers to information indicating a printing apparatus proposed as a printing apparatus that prints the printing target content. The information processing apparatus 1 can thus display the first or third apparatus selection image described above.

### Example of Printing Process

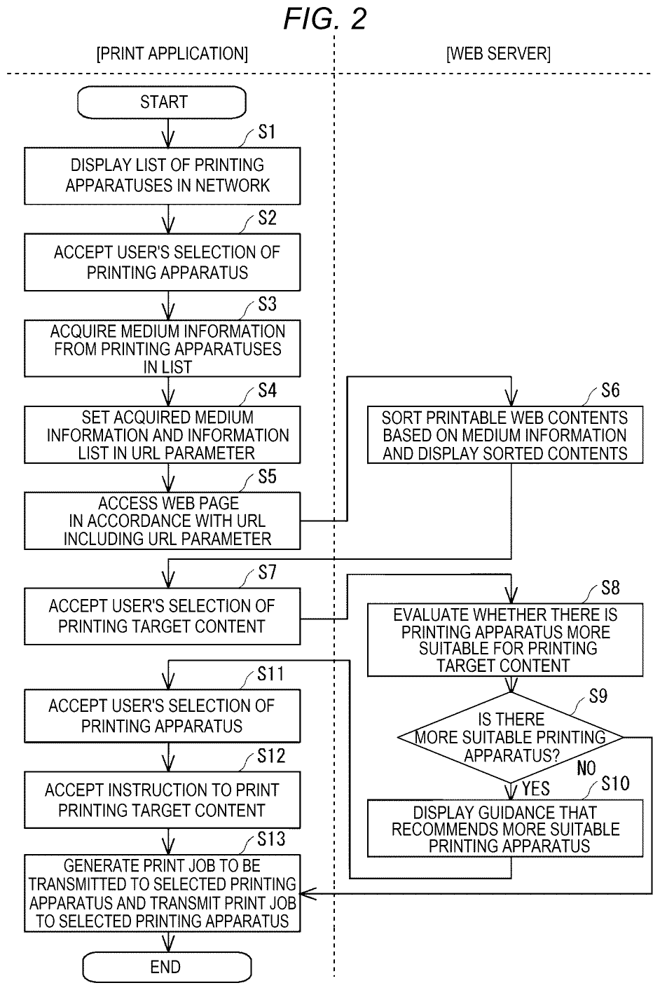

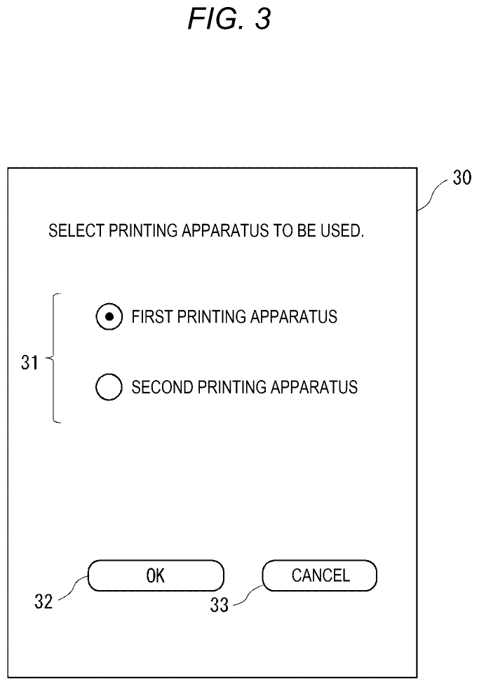

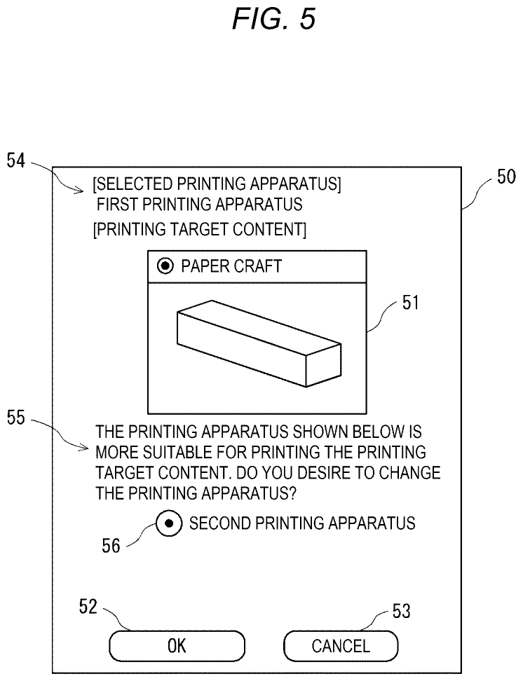

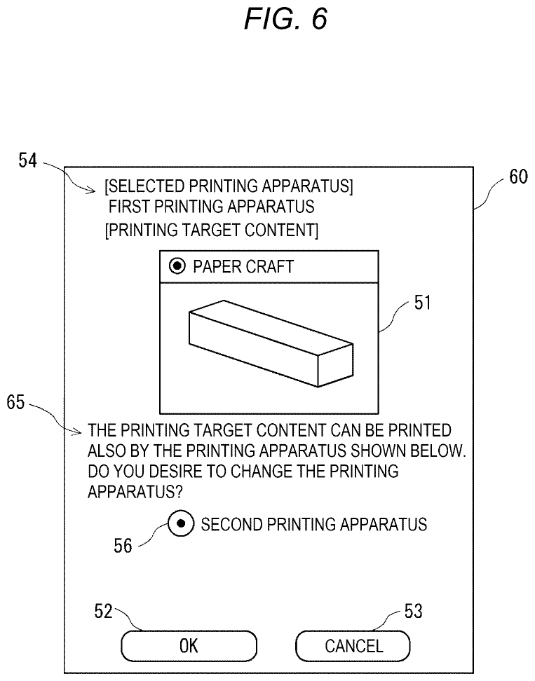

An example of the printing process carried out in the printing system 100 having the configuration described above will be described with reference to FIGS. 2 to 6. FIG. 2 is a flowchart for illustrating an example of the printing process. FIGS. 3 to 5 show an example of a series of UI images displayed on the information processing apparatus 1 in the printing process shown in FIG. 2. FIG. 6 shows an alternative example of the UI image shown in FIG. 5.

The following description will be made with reference to a case where the display processing section 10a, the evaluation section 10b, and the print processing section 10c in the information processing apparatus 1 are incorporated in one piece of print application software in an executable manner. The print application software is hereinafter simply referred to as a print application. The following description will be made with reference to a case where the server apparatus 2 is a Web server. The following description will also be made with reference to a case where the user selects a printing apparatus and then selects a printing target content.

The print application first searches for printing apparatuses usable in the network N and causes the display section 12 to display a list of printing apparatuses (step S1). The search is performed, for example, by broadcasting a call to the printing apparatuses in the network N and acquiring responses to the call, as described above. The following description will be made with reference to a case where the list of printing apparatuses provided as a result of the search includes the first printing apparatus 3a and the second printing apparatus 3b. In step S1, the print application can cause the display section 12 to display a list of printing apparatuses, for example, in the form of a UI image 30 shown in FIG. 3.

The UI image 30 is an example of the second apparatus selection image. The UI image 30 includes a radio button group 31, which includes the list of the names of the first printing apparatus 3a and the second printing apparatus 3b along with radio buttons associated with the printing apparatuses. The UI image 30 further includes an OK button 32 and a cancel button 33.

The print application then accepts the user's selection of a printing apparatus from the UI image 30 (step S2). The user can turn on the radio button associated with the printing apparatus that the user desires to use among the radio buttons of the ratio button group 31, and select the OK button 32 to select the printing apparatus indicated by the turned-on radio button as the printing apparatus to be used. In this process, the user can select one of the multiple printing apparatuses displayed in the UI image 30. FIG. 3 shows a state in which the first printing apparatus 3a has been selected. Through the user's selection, the print application may acquire, from the first printing apparatus 3a or driver software for the first printing apparatus 3a, information on functions executable by the first printing apparatus 3a, for example, the first medium information and the first ink information. When the cancel button 33 is selected in the UI image 30, the print application may terminate the process.

The print application then acquires the medium information relating to the printing apparatuses from the first printing apparatus 3a and the second printing apparatus 3b, which are printing apparatuses in the list contained in the UI image 30, or from the driver software for the printing apparatuses (step S3). In step S3, the ink information relating to the printing apparatuses can also be acquired in addition to the medium information relating to the printing apparatuses.

The print application then sets the apparatus information, the acquired medium information, or the acquired medium information and ink information in the URL parameter for each of the printing apparatuses (step S4). In the description, the medium information and other pieces of information relating to the second printing apparatus 3b, which may not be used, are contained in the URL parameter to be recommended to the user. The print application then accesses a Web page in the Web server in accordance with the URL including the thus set URL parameter (step S5).

When the URL indicating the access destination that the Web server accesses is [https://www.xxx], the URL including the URL parameter is, for example, as follows:

[https://www.xxx/?selected printer=3a&sp_medium=plain&candidate_printer=3b&cp_medium=photo]

The example described above indicates that the selected printing apparatus “selected_printer” is the first printing apparatus 3a “3a”, and the medium “sp_medium” used by the selected printing apparatus is plain sheets “plain”. In the following example, the candidate printing apparatus “candidate_printer” is the second printing apparatus 3b “3b”, and the medium “cp_medium” used by the candidate printing apparatus is photo sheets “photo”. The print application thus generates a URL parameter including a desire parameter according to the selection of a printing apparatus and a candidate parameter according to printing apparatuses that have not been selected but are provided. The description is made on the assumption that the first apparatus information on the first printing apparatus 3a having been selected as the printing apparatus used for the candidate parameter is not contained. However, even when the first apparatus information is contained in the candidate parameter, the comparison between the candidate parameter and the desire parameter allows the user to grasp the second printing apparatus 3b, which is a printing apparatus that has not been selected but is provided in the printing system.

The Web server accessed by the print application in accordance with the URL including the URL parameter described above sorts printable Web contents based on the medium information or the medium information and the ink information indicated by the URL parameter, and controls the display section 12 to display the sorted Web contents (step S6).

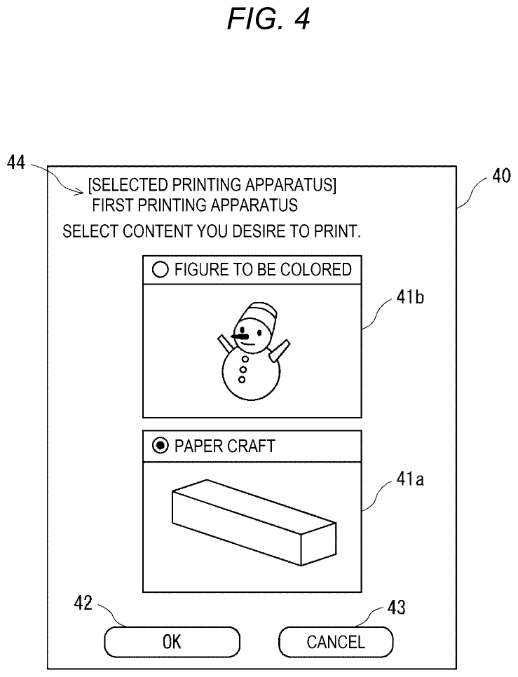

The print application thus displays a UI image such as a UI image 40 shown in FIG. 4, and accepts the user's selection of the printing target content from the UI image (step S7).

The UI image 40 is an example of the content selection image. The UI image 40 contains an image 41b of a figure to be colored and an image 41a of a paper craft, the images each having a radio button that allows the user's selection. The UI image 40 shows the images 41a and 41b having been sorted by the Web server based on the apparatus information on the selected first printing apparatus 3a. The example shown in FIG. 4 means that, in accordance with the example of the URL parameter settings described above, the image 41b can be printed more suitably than the image 41a by the selected first printing apparatus 3a, which uses plain sheets as the medium. Furthermore, the UI image 40 only shows extracted images printable at least by the selected first printing apparatus 3a. The extraction described above can prevent display of contents that cannot be printed, for example, because the selected first printing apparatus 3a does not support media for Web contents.

The UI image 40 may, of course, contain a larger number of images or a scroll bar. For example, a content printable by the second printing apparatus 3b, which has been determined based on the URL parameter by the Web server as a printing apparatus that has not been selected by the user but is provided in the printing system, can be displayed in the UI image 40. Furthermore, regardless of the type of the image to be contained in the UI image 40, the UI image 40 may contain multiple images different in version from each other, as described above, for example, images generated from the same original image but different, for example, in resolution from each other. The method for selecting an image in the UI image 40 is not limited to a radio button, and various methods, such as simply selecting the entire image, can be employed. Moreover, the UI image 40 may contain an OK button 42, a cancel button 43, and information 44 indicating the printing apparatus selected by the user and accepted in step S2.

The user can turn on the radio button associated with the content that the user desires to print out of the images 41a and 41b, and select the OK button 42 to select the content indicated by the turned-on radio button as the printing target content. FIG. 4 shows a state in which the image 41a has been selected. The print application conveys the user's selection to the Web server. Note that when the cancel button 43 is selected in the UI image 40, the print application may terminate the process.

The Web server having received the information indicating the user's selection of the printing target content evaluates whether the printing apparatus more suitable for printing the printing target content is any of the candidate printing apparatuses, that is, the printing apparatuses that have not been selected but are provided in the printing system (step S8). Herein, a case where the candidate printing apparatus is only the second printing apparatus 3b is shown. In step S8, the Web server may perform the evaluation, for example, by referring to the table described above based on each piece of information received from the print application. For example, when the image of a paper craft such as the image 41a is selected as the printing target content, it can be said that photo sheets used in the second printing apparatus 3b are more suitable than plain sheets used in the first printing apparatus 3a because photo sheets are thicker than plain sheets.

When the result of the evaluation in step S8 indicates that the more suitable printing apparatus is any of the candidate printing apparatuses, that is, when the result of the evaluation in step S9 is YES, the Web server performs control to display guidance that recommends a more suitable printing apparatus (step S10). The print application thus displays a UI image such as a UI image 50 shown in FIG. 5, and accepts the user's selection of change in the printing apparatus from the UI image (step S11). The process described above allows the user to specify a more suitable printing apparatus and perform the printing.

The UI image 50 is an example of the first apparatus selection image. The UI image 50 contains an image 51 corresponding to the image 41a, which is the printing target content, an OK button 52, and a cancel button 53. The UI image 50 further contains information 55, which represents guidance that recommends a more suitable printing apparatus, such as “The printing apparatus shown below is more suitable for printing the printing target content. Do you desire to change the printing apparatus?”, and a radio button 56. The radio button 56 is a radio button that allows the user to select the second printing apparatus 3b, which is the more suitable printing apparatus. The UI image 50 further contains information 54 indicating the currently selected printing apparatus. That is, the UI image 50 allows modification of the user's selection of the printing apparatus made in the previously displayed UI image 30.

In step S11, when the user does not desire to stop using the first printing apparatus 3a, the user selects the OK button 52 with the radio button 56 turned off. On the other hand, when the user desires to use the second printing apparatus s 3b in place of the first printing apparatus 3a, the user selects the OK button 52 with the radio button 56 turned on in step S11. The UI image 50 shows a state in which the second printing apparatus 3b is selected. Note that when the cancel button 53 is selected in the UI image 50, the print application may terminate the process.

When the OK button 52 is selected, the print application accepts an instruction to print the printing target content (step S12). The print application then generates a print job of printing the image 41a to be transmitted to the printing apparatus selected in step S11, and transmits the print job to the printing apparatus (step S13). In step S13, when the printing apparatus selected in step S11 is the second printing apparatus 3b, the print job to be transmitted to the second printing apparatus 3b is generated and transmitted to the second printing apparatus 3b. The second printing apparatus 3b thus prints the image 41a, that is, the image 51, and the printing process ends. On the other hand, when the printing apparatus selected in step S11 is still the first printing apparatus 3a, the print job to be transmitted to the first printing apparatus 3a is generated and transmitted to the first printing apparatus 3a in step S13. The first printing apparatus 3a thus prints the image 41a, that is, the image 51, and the printing process ends.

When the result of the evaluation in step S8 shows that any of the candidate printing apparatuses is not a more suitable printing apparatus, that is, when the result of the evaluation in step S9 is NO, the Web server returns the result to the print application. For example, when the image of a figure to be colored such as the image 41b is selected as the printing target content, it can be said that plain sheets used in the first printing apparatus 3a are more suitable than photo sheets used in the second printing apparatus 3b, so that the result of the evaluation in step S9 is NO. The print application then generates a print job of printing the image 41b to be transmitted to the first printing apparatus 3a, which is the printing apparatus selected first in step S2, and transmits the print job to the first printing apparatus 3a (step S13). The first printing apparatus 3a thus prints the image 41b, and the printing process ends.

As shown in the case where the result of the evaluation in step S9 is NO by way of example, when the printing target content selected from the content selection image is not printable by the second printing apparatus 3b, the print application may not display the second printing apparatus 3b as a selectable printing apparatus in the first apparatus selection image.

Furthermore, as shown in the case where the result of the evaluation in step S9 is NO by way of example, the print application may carry out the process below. That is, when the printing target content selected from the content selection image is not printable by the second printing apparatus 3b, the print application may transmit a print job of printing the printing target content to the first printing apparatus 3a without displaying the first apparatus selection image.

In steps S8 and S10, a printing apparatus more suitable for printing the printing target content is determined and recommended. Instead, a printing apparatus capable of printing the printing target content may be simply determined and displayed as guidance for the user's reference. A UI image 60 shown in FIG. 6 is presented as an example of the UI image for the user's reference. The UI image 60 contains information 65 indicating guidance for the user's reference, such as “The printing target content can be printed also by the printing apparatus shown below. Do you desire to change the printing apparatus?” in place of the information 55 in the UI image 50.

FIG. 2 shows the case where the user selects a printing target content after selecting a printing apparatus, and the user may instead select a printing apparatus after selecting a printing target content. In this case, the user may be prompted to select a printing apparatus from among the candidate print apparatuses with the printing target content contained in the UI image. In this process, when the candidate printing apparatuses are superior or inferior in terms of beauty or the like of the printed printing target content, the UI image may contain a description of the superiority or inferiority, or may contain the printing apparatuses sorted in descending order of superiority in addition to the description.

### Variations of Parameters

Various pieces of information, such as regional information on the region where the user is present, and information representing the period for which a website is browsed, may be added to the URL parameter described above. The regional information can be acquired, for example, by the communication section 14 of the information processing apparatus 1 or by a separately provided position information acquisition section.

Adding the regional information on the region where the user is present to the URL parameter allows the user to be guided to Web contents specific to the region where the user is present. The region-specific Web contents may refer, for example, to contents showing events currently popular in the region. Adding the information representing the period for which a website is browsed to the URL parameter allows the user to be guided to a Web content according to the browsing period. A Web content according to the browsing period may refer, for example, when the browsing period falls within greeting periods such as the end-of-year holidays and the new year holidays, to a Web content relating to the greetings. Furthermore, for example, when the browsing period falls within greeting periods such as the end-of-year holidays and the new year holidays but falls, for example, within a weekday time zone, where no work time can be spared, Web contents relating to the greetings may not be recommend.

### Effects of Present Embodiment

As described above, the present embodiment provides an effect of improving the user's convenience when a content that matches the user's printing environment is printed. For example, the present embodiment includes the following processes: presenting printing apparatuses that can print contents; sorting the contents and displaying the sorted contents; accepting the user's selection of a content from among the contents; and making a display showing that the selected content can be printed also by candidate printing apparatuses that have not been specified by the user. The processes described above can be realized, for example, because the server apparatus 2 can grasp the printing environment of the information processing apparatus 1, for example, the print application can function in cooperation with a Web content. In the present embodiment, the processes described above allow the user to readily select a printing apparatus that matches the content that the user desires to print.

The present embodiment can therefore prevent, for example, a Web content from being printed by a printing apparatus that is not very suitable for the Web content, or a Web content that cannot be printed by the user's printing apparatus from being presented. As a result, the present embodiment can reduce the number of times the user redoes the user's operation, such as selection of a content or selection of a printing apparatus.

### Other Variations

The present disclosure is not limited to the embodiment described above, and can be modified as appropriate without departing from the intent of the present disclosure. For example, the information processing apparatus, the server apparatus, and the printing apparatus may each be any apparatus capable of providing the functions described above. Furthermore, the present disclosure may employ an apparatus configured to carry out only some of the processes in the embodiment described above. For example, the present disclosure may employ an information processing apparatus configured to carry out a first parameter generation process based on detection of candidate printing apparatuses. The present disclosure may instead employ an information processing apparatus configured to carry out a second parameter generation process based on selection of a first printing apparatus.

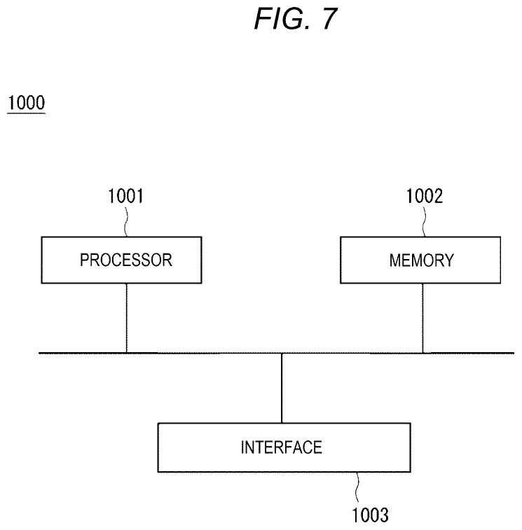

The apparatuses provided in the printing system according to the embodiment described above may, for example, have the hardware configuration below. The apparatuses refer to the information processing apparatus 1, the server apparatus 2, the first printing apparatus 3a, and the second printing apparatus 3b with reference, for example, to FIG. 1. FIG. 7 shows an example of the hardware configuration of an apparatus.

An apparatus 1000 shown in FIG. 7 may include a processor 1001, a memory 1002, and an interface 1003. The interface 1003 may include, for example, a communication interface or an interface with input and output apparatuses, which are necessary depending on the apparatus.

The processor 1001 may, for example, be a CPU, a GPU, or a microprocessor unit (MPU) also referred to as a microprocessor. The processor 1001 may include multiple processors. The memory 1002 is configured, for example, with a combination of a volatile memory and a nonvolatile memory. Functions of the apparatuses are realized by the processor 1001 reading a program stored in the memory 1002 and executing the program while exchanging necessary information via the interface 1003.

The program described above contains an instruction group (or software codes) that causes a computer to provide one or more of the functions described in the embodiment when the program is loaded into the computer. The program may be stored in a non-transitory computer-readable medium or a tangible storage medium. Examples of the computer-readable medium or the tangible storage medium include, but not limited to, a random-access memory (RAM), a read-only memory (ROM), a flash memory, a solid-state drive (SSD), and elements based on other memory technologies. Examples of the computer-readable medium or the tangible storage medium further include, but not limited to, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted via a transitory computer-readable medium or a communication medium. The transitory computer-readable medium or the communication medium may include, but not limited to, a signal that propagates electrically, optically, acoustically, or in other forms.

The present disclosure has been described with reference to the aforementioned embodiment. The present disclosure is not limited only to the configuration in the aforementioned embodiment, and it goes without saying that the present disclosure includes various variations, modifications, and combinations that can be achieved by those skilled in the art within the scope of the disclosure in the claims of the present application.

What is claimed is:

1. An information processing apparatus comprising:
a display section; an operation section; a communication section; and a controller,
wherein the controller is configured to
cause the display section to display a content selection image that is a user interface image from which a printing target content is selected,
evaluate whether the printing target content selected from the content selection image via the operation section is printable by a second printing apparatus that is a printing apparatus different from a first printing apparatus capable of printing the printing target content,
when the printing target content is printable by the second printing apparatus, cause the display section to display a first apparatus selection image that is a user interface image from which one of the first and second printing apparatuses is selected as a printing apparatus that prints the printing target content, and
transmit a print job of printing the printing target content via the communication section to a printing apparatus selected from the first apparatus selection image via the operation section.

2. The information processing apparatus according to claim 1, wherein
the controller is configured to
causes the display section to display a second apparatus selection image that is a user interface image from which a printing apparatus desired to be used is selected from among candidate printing apparatuses including the first and second printing apparatuses,
choose a printing apparatus selected from the second apparatus selection image via the operation section to be the first printing apparatus, and
cause the display section to display the content selection image after the printing apparatus desired to be used is selected from the second apparatus selection image.

3. The information processing apparatus according to claim 2, wherein
the controller is configured to acquire first medium information on a medium that allows the first printing apparatus to perform printing, and cause to display the content selection image based on the first medium information.

4. The information processing apparatus according to claim 1, wherein
the controller is configured to
after the printing target content is selected from the content selection image, cause t display section to display a second apparatus selection image that is a user interface image from which a printing apparatus desired to be used is selected from among candidate printing apparatuses including the first and second printing apparatuses, and
choose a printing apparatus selected from the second apparatus selection image via the operation section to be the first printing apparatus.

5. The information processing apparatus according to claim 1, wherein
the controller is configured to acquire second medium information on a medium that allows the second printing apparatus to perform printing, and evaluate based on the second medium information whether the printing target content is printable by the second printing apparatus.

6. The information processing apparatus according to claim 1, wherein
when the printing target content selected from the content selection image is not printable by the second printing apparatus, the controller is configured to cause not to display the second printing apparatus as a selectable printing apparatus in the first apparatus selection image.

7. The information processing apparatus according to claim 1, wherein
when the printing target content selected from the content selection image is not printable by the second printing apparatus, the controller is configured to cause not to display the first apparatus selection image but transmit a print job of printing the printing target content to the first printing apparatus.

8. The information processing apparatus according to claim 2, wherein
the controller is configured to detect, as the candidate printing apparatus, a printing apparatus capable of transmitting the print job from the information processing apparatus via a network connected to the information processing apparatus via the communication section.

9. An information processing apparatus comprising:
a communication section; and a controller,
wherein the controller is configured to
detect, as candidate printing apparatuses, a printing apparatus capable of transmitting a print job via a network connected to the information processing apparatus via the communication section,
carry out a generation process of generating a URL (uniform resource locator) that includes a first parameter that is a parameter indicating print positions of the detected candidate printing apparatuses and indicates an access destination allowing access to a server apparatus configured to store the printing target content, and
access the server apparatus via the communication section based on the URL.

10. The information processing apparatus according to claim 9, further comprising:
a display section; and an operation section,
wherein the controller is configured to
cause the display section to display a first apparatus selection image that is a user interface image from which a printing apparatus desired to be used is selected from among the candidate print apparatuses via the operation section, and
select a printing apparatus selected from the first apparatus selection image via the operation section as a first printing apparatus that is a printing apparatus that prints the printing target content, and
the generation process generates, as the URL, a URL containing the first parameter and a second parameter that is a parameter indicating the first printing apparatus.

11. The information processing apparatus according to claim 10, wherein
the first parameter includes a parameter indicating a second printing apparatus that is a printing apparatus detected as one of the candidate printing apparatuses but is not selected from the first apparatus selection image via the operation section.

12. The information processing apparatus according to claim 10, wherein
the controller is configured to
acquire, via the communication section, contents extracted or sorted by the server apparatus based on the second parameter, and
cause the display section to display a content selection image that is a user interface image from which the printing target content is selected from among the acquired contents via the operation section.

13. The information processing apparatus according to claim 9, further comprising:
a display section; and an operation section,
wherein the controller is configured to cause the display section to display a second apparatus selection image that is a user interface image from which selecting, via the operation section, a printing apparatus proposed based on the first parameter by the server apparatus as a printing apparatus that prints the printing target content.

14. A printing system comprising:
an information processing apparatus including a display section, an operation section, a communication section, and a controller;
a first printing apparatus; and
a second printing apparatus,
wherein the controller is configured to
cause the display section to display a content selection image that is a user interface image from which a printing target content is selected,
when the printing target content selected from the content selection image via the operation section is printable by the first printing apparatus, evaluate whether the printing target content is printable by the second printing apparatus,
when the printing target content is printable by the second printing apparatus, cause the display section to display a first apparatus selection image that is a user interface image from which one of the first and second printing apparatuses is selected as a printing apparatus that prints the printing target content, and
transmit a print job of printing the printing target content via the communication section to a printing apparatus selected from the first apparatus selection image via the operation section.

15. A program configured to cause a computer including a display section, an operation section, and a communication section to
cause the display section to display a content selection image that is a user interface image from which a printing target content is selected,
evaluate whether the printing target content selected from the content selection image via the operation section is printable by a second printing apparatus that is a printing apparatus different from a first printing apparatus capable of printing the printing target content,
when the printing target content is printable by the second printing apparatus, cause the display section to display a first apparatus selection image that is a user interface image from which one of the first and second printing apparatuses is selected as a printing apparatus that prints the printing target content, and
transmit a print job of printing the printing target content via the communication section to a printing apparatus selected from the first apparatus selection image via the operation section.
